(19) United States
(12) Patent Application Publication
(10) Pub. No.: US 2026/0010591 A1
(43) Pub. Date: Jan. 8, 2026

(54) CHALLENGE-RESPONSE AUTHENTICATION USING GENERATIVE ARTIFICIAL INTELLIGENCE

(71) Applicant: Kyndryl, Inc., New York, NY (US)

(72) Inventors: Cesar Augusto Rodriguez Bravo, Alajuela (CR); Kim A. Eckert, Austin, TX (US); Chris Bode, Holly Springs, NC (US)

(21) Appl. No.: 18/762,810

(22) Filed: Jul. 3, 2024

(51) Int. Cl. G06F 21/31

(52) U.S. Cl. CPC G06F 21/31; G06F 2221/2133

(57) ABSTRACT

Computer-implemented methods for a challenge-response authentication system using generative artificial intelligence (AI). Aspects include generating a prompt for an object of a randomly selected output type. Aspects further include generating a solution object of the randomly selected output type based on the prompt using a generative AI engine. Aspects also include generating a candidate object of the randomly selected output type based on a modified prompt using the generative AI engine. Aspects further include presenting a challenge-response test comprising a question based on the prompt, the solution object, and the candidate object to a user device. Aspects also include performing a responsive action in response to receiving a response to the challenge-response test from the user device comprising an object selection.

### BACKGROUND

The present invention generally relates to computer systems, and more specifically, to computer-implemented methods, computer systems, and computer program products configured and arranged to provide a challenge-response authentication system using generative artificial intelligence.

Bots, also known as crawlers or Internet bots, are software applications that execute scripts for automated and repetitive tasks. Malicious bots or malware bots perform activities that can create security risks and impact performance of a website or application. Security risks imposed by malicious bots include Denial of Service attacks, unsolicited messages, fraudulent website traffic, registration spam, data scraping and the like. Many website and software applications utilize anti-bot measures, such as a challenge-response test, to deter malicious bot activity.

An example of a challenge-response test for authentication is Completely Automated Public Turing test to tell Computers and Humans Apart (CAPTCHA), which is a test designed to determine whether the user is a human by requiring the user to complete tasks that utilize sensory and cognitive skills that pose significant challenges for computer software to solve. For example, a modern text-based CAPTCHA can present a random assortment of characters or a word that has been visually distorted and requesting the user to identify the characters or words. The CAPTCHA may require that the user view an image, recognize characters despite variations in their shapes and sizes, separate the characters from each other, and identify each character.

### SUMMARY

Embodiments of the present invention are directed to computer-implemented methods for a challenge-response authentication system using generative artificial intelligence. A non-limiting computer-implemented method includes generating a prompt for an object of a randomly selected output type. The method also includes generating a solution object of the randomly selected output type based on the prompt using a generative artificial intelligence (AI) engine. The method further includes generating a candidate object of the randomly selected output type based on a modified prompt using the generative AI engine. The method also includes presenting a challenge-response test that includes a question based on the prompt, the solution object, and the candidate object to a user device. The method further includes, in response to receiving a response to the challenge-response test from the user device that includes an object selection, performing a responsive action.

In one embodiment of the present invention, the generative AI engine is a text-to-image generative AI engine, a text-to-video generative AI engine, a text-to-audio generative AI engine, or a text-to-text generative AI engine.

In one embodiment of the present invention, wherein the responsive action includes determining that the object selection of the response matches the solution object and granting the user device access to a protected resource.

In one embodiment of the present invention, the responsive action includes determining that the object selection of the response does not match the solution object and performing a security action that includes preventing access to a protected resource for the user device or presenting a second question, a second solution object, and a second candidate object to the user of the user device.

In one embodiment of the present invention, the method includes generating the modified prompt by removing an entity from the prompt.

In one embodiment of the present invention, the method includes generating, by a text-to-text generative AI engine, the question based on the prompt.

In one embodiment of the present invention, the output type is audio, video, text, or image.

According to another non-limiting embodiment of the invention, a system having a memory having computer readable instructions and one or more processors for executing the computer readable instructions, the computer readable instructions controlling the one or more processors to perform operations. The operations include generating a prompt for an object of a randomly selected output type. The operations also include generating a solution object of the randomly selected output type based on the prompt using a generative artificial intelligence (AI) engine. The operations further include generating a candidate object of the randomly selected output type based on a modified prompt using the generative AI engine. The operations also include presenting a challenge-response test that includes a question based on the prompt, the solution object, and the candidate object to a user device. The operations further include, in response to receiving a response to the challenge-response test from the user device that includes an object selection, performing a responsive action.

According to another non-limiting embodiment of the invention, a computer program product is provided. The computer program product includes a computer-readable storage medium having program instructions embodied therewith, the program instructions executable by a processor to cause the processor to perform operations. The operations include generating a prompt for an object of a randomly selected output type. The operations also include generating a solution object of the randomly selected output type based on the prompt using a generative artificial intelligence (AI) engine. The operations further include generating a candidate object of the randomly selected output type based on a modified prompt using the generative AI engine. The operations also include presenting a challenge-response test that includes a question based on the prompt, the solution object, and the candidate object to a user device. The operations further include, in response to receiving a response to the challenge-response test from the user device that includes an object selection, performing a responsive action.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of an example computer system for use in conjunction with one or more embodiments of the present invention;

FIG. 2 is a block diagram of an example system for a challenge-response authentication system using generative AI in accordance with one or more embodiments of the present invention;

FIG. 3 is a data flow diagram for an example system for a challenge-response authentication system using generative AI in accordance with one or more embodiments of the present invention;

FIG. 4 is a block diagram of an example challenge-response test for an example challenge-response authentication system using generative AI in accordance with one or more embodiments of the present invention;

FIG. 5 is a flowchart of a computer-implemented method for a challenge-response authentication system using generative AI in accordance with one or more embodiments of the present invention;

FIG. 6 depicts a cloud computing environment in accordance with one or more embodiments of the present invention; and

FIG. 7 depicts abstraction model layers in accordance with one or more embodiments of the present invention.

### DETAILED DESCRIPTION

Disclosed herein are methods, systems, and computer program products for a challenge-response authentication system using generative artificial intelligence (AI). As discussed above, malicious bots perform activities that can create security risks and impact the performance of a website or application. Anti-bot measures, such as a challenge-response test, are used to deter malicious bot activity. With the acceleration of public availability and sophistication of artificial intelligence systems, current challenge-response tests are vulnerable to bots that are capable of circumventing existing challenge-response authentication systems.

The systems and methods described herein are directed to a challenge-response authentication system that uses generative AI to deter malicious bots. The challenge-response authentication system is an automated system that uses generative AI to generate objects or assets to use in challenge-response tests to provide security validation for protected resources, such as content, applications, or the like. There is an increased level of security because the objects or assets that will be used in the challenge-response test are newly generated by the generative AI and the object type of the objects is randomly selected. If the assets or objects used in the challenge-response test are stored or previously generated, malicious bots may be able to access them and use them to circumvent the challenge-response test.

In some embodiments, the system receives a request from a user device to access a protected resource. To determine whether the request is from a human user or a malicious bot, the system generates a challenge-response test. If the user is able to successfully solve the challenge-response test presented by the system, the system grants the user device access to the protected resource. However, if the user is unable to solve the challenge-response test, the system performs a security action, such as banning/excluding the user device or generating a new challenge-response test for the user.

The systems and methods described herein are directed to a challenge-response authentication system that leverages generative AI. The challenge-response authentication system uses the generative AI technologies to create objects and requests the user to identify one or more of the objects with a given characteristic. Examples of given characteristics of objects include videos that do not have audio, objects with the longest audio, videos that are related to cars, a word that does not exist, a lyric with a happy mood, a character with blue eyes, an image of a car with 2 doors, an image of shoes without laces, an image of a car without headlamps, and the like.

In some embodiments, the system creates the challenge-response test by leveraging generative AI technologies to create a prompt which is then used to generate a set of assets or objects with a given characteristic. A prompt is a text command or instruction for a generative AI engine. The system then removes entities or otherwise modifies the original prompt and then uses the modified prompt to generate another set of assets or objects. The original prompt is then transformed into a question using a large language model or similar technology. The challenge-response test is generated using the first set of assets or objects that correspond to the original prompt, the second set of assets or objects that correspond to the modified prompt, and the question generated from the original prompt. The system generates the challenge-response test to include the question, the first set of assets or objects corresponding to the original prompt, and the second set of assets or objects corresponding to the modified prompt. The challenge-response test requests the user to identify or select one or more assets or objects that have a particular set of attributes.

In one example, the challenge-response authentication system generates a challenge-response test that contains multiple audio objects and requests the user to select the objects that have a given characteristic. Examples of the characteristic can include the audio that uses a guitar, the audio that does not contain a guitar, the audio with a rock style, the audio that includes a voice, the audio that is an instrumental, or the like.

In another example, the challenge-response authentication system generates a challenge-response test that contains multiple video objects and requests the user to select the objects that have a given characteristic. Examples of the characteristic can include the video that does not have a train, the video that does not have audio, the video that does not have people, or the like.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

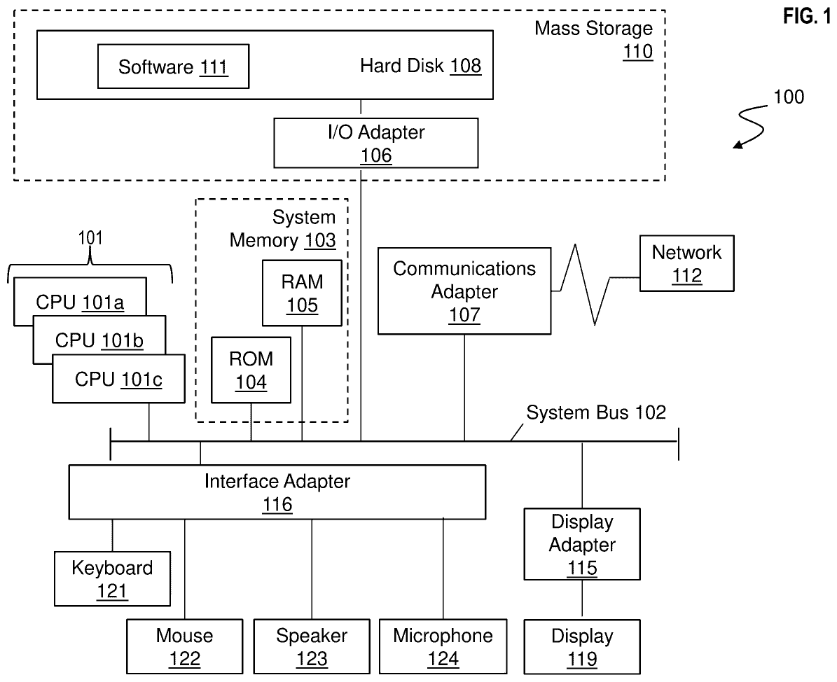

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random-access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

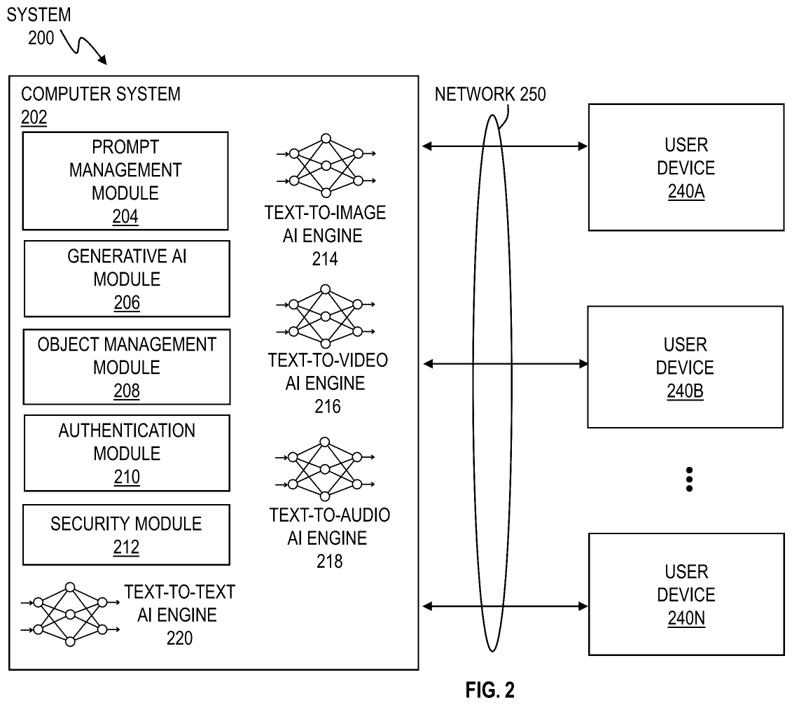

FIG. 2 depicts a block diagram of an example system 200 configured for a challenge-response authentication system using generative AI according to one or more embodiments. The system 200 includes a computer system 202 configured to communicate over a network 250 with many different user devices, such as user device 240A, user device 240B, through user device 240N. The user devices 240A, 240B, through 240N can generally be referred to as user device 240 and are utilized to access, for example, a protected resource. The user device 240 can be a personal computer or laptop. The user device 240 can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The user devices 240 can include various software and hardware components including software applications (apps) for communicating with one another over the network 250 as understood by one of ordinary skill in the art. The computer system 202, user device(s) 240, prompt management module 204, generative AI module 206, object management module 208, authentication module 210, security module 212, text-to-image AI engine 214, text-to-video AI engine 216, text-to-audio AI engine 218, text-to-text AI engine 220, etc., can include functionality and features of the computer system 100 in FIG. 1 including various hardware components and various software applications such as software 111 which can be executed as instructions on one or more processors 101 in order to perform actions according to one or more embodiments of the invention. The prompt management module 204, generative AI module 206, object management module 208, authentication module 210, security module 212, text-to-image AI engine 214, text-to-video AI engine 216, text-to-audio AI engine 218, and text-to-text AI engine 220 can include, be integrated with, and/or call other pieces of software, algorithms, application programming interfaces (APIs), etc., to operate as discussed herein.

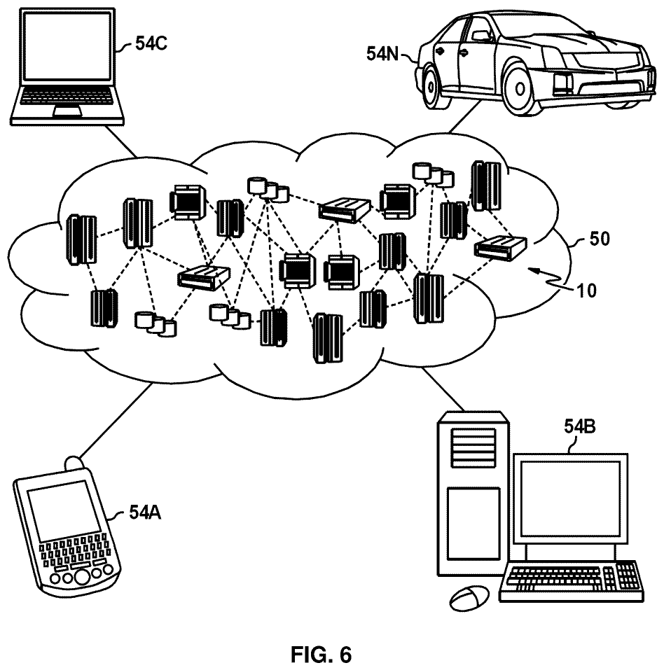

The computer system 202 may be representative of numerous computer systems and/or distributed computer systems configured to provide security services to a user of the user device 240. The computer system 202 can be part of a cloud computing environment such as a cloud computing environment 50 depicted in FIG. 6, as discussed further herein.

In some embodiments, the computer system 202 can include one or more components to provide a challenge-response authentication system using generative AI. For example, the computer system 202 can include a prompt management module 204, generative AI module 206, object management module 208, authentication module 210, security module 212, text-to-image AI engine 214, text-to-video AI engine 216, text-to-audio AI engine 218, and/or text-to-text AI engine 220.

In some embodiments, the text-to-image AI engine 214, text-to-video AI engine 216, text-to-audio AI engine 218, and/or text-to-text AI engine 220 are created and trained by the challenge-response authentication system. In some embodiments, the challenge-response authentication system leverages already trained AI engines. The challenge-response authentication system identifies available generative AI engines based on user preferences and expertise. In some embodiments, the challenge-response authentication system uses a mix of available generative AI engines and AI engines that it creates and trains.

In some embodiments, prompt management module 204 randomly selects an output type. Examples of output types include, but are not limited to, audio, video, text, or image. The prompt management module 204 communicates with the generative AI module 206 to generate a prompt that will be used to generate objects of the randomly selected output type. In some embodiments, the generative AI module 206 selects an AI engine to generate the prompt and transmits the prompt generated by the selected AI engine back to the prompt management module 204. For example, the prompt management module 204 selects audio as the output type and the generated prompt is “create an audio object without guitar.”

The prompt management module 204 communicates the prompt and the output type to the object management module 208. The object management module 208 communicates with the generative AI module 206. The object management module 208 transmits the prompt and the output type to the generative AI module 206. The generative AI module 206 selects an AI engine based on the output type. For example, since the output type in the example is audio, the generative AI module 206 selects the text-to-audio AI engine 218. The text-to-audio AI engine 218 generates one or more solution objects (e.g., audio files) and transmits them to the object management module 208. Solution objects are objects that are created and correspond to the prompt.

In some embodiments, the number of solution objects is determined by an administrator of the system. In some embodiments, a maximum value for objects is set for the challenge-response test. The number of solution objects can be a randomly generated value less than the maximum value. The number of candidate objects generated later is the maximum value minus the number of solution objects generated.

After the solution objects are received, the object management module 208 communicates with the prompt management module 204. The prompt management module 204 transmits the prompt to the text-to-text AI engine 220, which then generates a modified prompt. In some embodiments, the text-to-text AI engine 220 generates the modified prompt by removing and/or modifying one or more entities or characteristics from the prompt. For example, the prompt “create an audio object without guitar” is transformed into a modified prompt “create an audio object with guitar” or “create an audio object.”

The prompt management module 204 communicates the modified prompt to the object management module 208. The object management module 208 communicates with the generative AI module 206. The object management module 208 transmits the modified prompt and the output type to the generative AI module 206. The generative AI module 206 uses the previously selected AI engine to generate one or more candidate objects. For the given example, the generative AI module 206 uses the text-to-audio AI engine 218 to generate one or more candidate objects (e.g., audio files) and transmits them to the object management module 208. Candidate objects are objects that are created and correspond to the modified prompt and not the original prompt and are objects that are to be shown with the solution objects in the challenge-response test as possible answers.

The prompt management module 204 transmits the prompt to the text-to-text AI engine 220 to transform the prompt to a question for the challenge-response test. For example, the prompt “create an audio object with guitar” is transformed into the question “Which audio includes the guitar?”

In some embodiments, the authentication module 210 receives the request to access protected resource and initiates the generation of a challenge-response test. In some embodiments, the authentication module 210 communicates with the prompt management module 204 to initiate the generation of the challenge-response test.

The authentication module 210 receives the question from the prompt management module 204 and the solution object(s) and candidate object(s) from the object management module 208 and generates the challenge-response test. The authentication module 210 transmits the challenge response test to the user device 240A. For example, the authentication module 210 causes the challenge response test to be graphically displayed on the user device 240A.

The user device 240A receives and displays the challenge-response test to the user. The user views the question, candidate object(s), and solution object(s). The user selects one or more displayed objects and selects a SUBMIT button on the challenge-response test. In response to the selection of the SUBMIT button, a response is generated and transmitted to the authentication module 210. The response includes the selection of objects made by the user.

The authentication module 210 receives the response from the user device 240A. The authentication module 210 compares the selection of objects made by the user to the solution object(s) and takes a responsive step. For example, if the authentication module 210 determines that the user selection from the response matches all of the solution object(s), the authentication module 210 will flag the authentication as successful and provide access to the protected resource requested by the user device 240A. If the authentication module 210 determines that the user selection does not match all of the solution object(s), the authentication module 210 will communicate with the security module 212, which will perform a security action. In some embodiments, the security action locks out the user or presents a second challenge-response test. In some embodiments, the security action is to ban/exclude the user device 240A or lockout the user device 240A for a predetermined amount of time (e.g., 10 minutes, 1 day, etc.) if the user device 240A fails the challenge-response test a predetermined number of times.

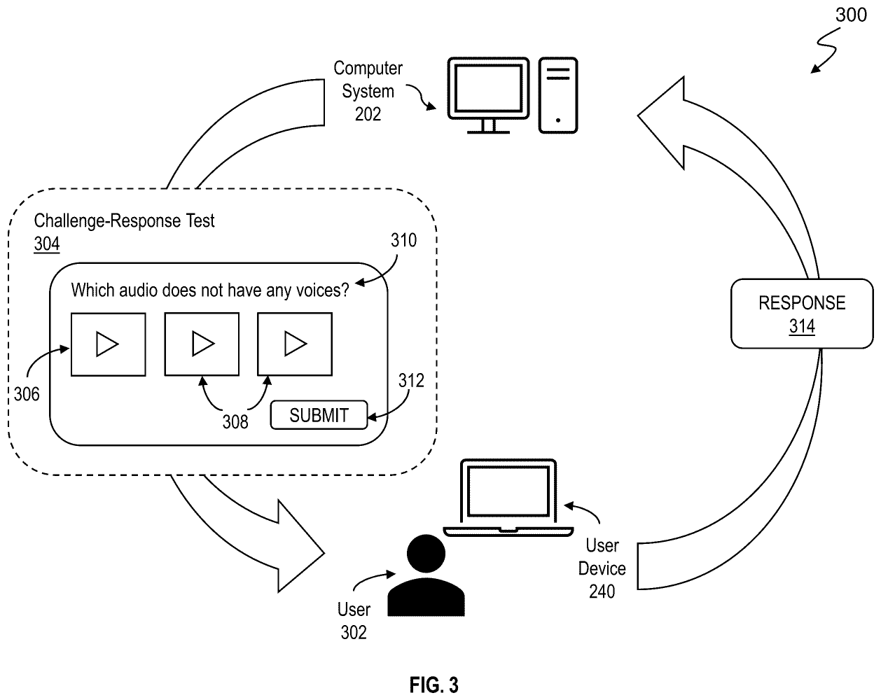

FIG. 3 is a data flow diagram 300 for an example system for a challenge-response authentication system using generative AI in accordance with one or more embodiments of the present invention. In some embodiments, a user 302 logs into a user device 240 and attempts to navigate a resource, such as content on a website. The computer system 202 receives the request to access the resource and initiates the challenge-response authentication, such as a CAPTCHA, to ensure that the user 302 is a human. In some embodiments, the computer system 202 presents a challenge-response test 304 to the user 302. The computer system 202 randomly selects an output type, such as video, text, audio, or image. The computer system 202 then uses a generative AI engine to generate a prompt. The computer system 202 generates candidate objects of the previously selected output type.

In the example depicted in FIG. 3, the output type randomly selected by the computer system 202 is audio. The computer system 202 uses a generative AI engine to generate a prompt for the randomly selected output type. For example, the generative AI engine generates the prompt for audio, “create an audio file without voices.” The computer system 202 uses a text-to-audio AI engine, such as text-to-audio AI engine 218, to generate one or more solution objects 306 of the selected output type (i.e., audio files) based on the prompt. The solution objects 306 can be audio files that do not have any voices. The computer system 202 modifies the prompt and then uses the text-to-audio AI engine, such as text-to-audio AI engine 218, to generate one or more candidate objects 308 based on the modified prompt. For example, the generative AI engine generates the modified prompt for audio, “create an audio file with voices” such that the candidate objects 308 are audio files with voices. The computer system 202 uses a text-to-text AI engine, such as text-to-text AI engine 220, to transform the prompt into a question 310. For example, the question 310 for the prompt “create an audio file without voices” is “Which audio does not have any voices?” The computer system 202 then includes the question 310, solution object 306, and the candidate objects 308 in the challenge-response test 304 and facilitates displaying the challenge-response test 304 to a user 302 of a user device 240.

In the example depicted in FIG. 3, the user 302 listens to the solution object 306 and the candidate objects 308 presented in the challenge-response test and then selects one of the objects that the user decides is the answer to the displayed question 310. The user 302 selects the SUBMIT button 312 to indicate that they have finished the challenge-response test 304. A response 314 is generated and includes the selection of the user 302. The computer system 202 receives the response 314 and determines if the solution object 306 was selected by the user 302. If the solution object 306 was selected, the user device 240 is granted access to the requested resource. If the solution object 306 was not selected, the computer system 202 performs a security action, such as locking out the user device 240 from accessing the resource or presenting another challenge-response test 304.

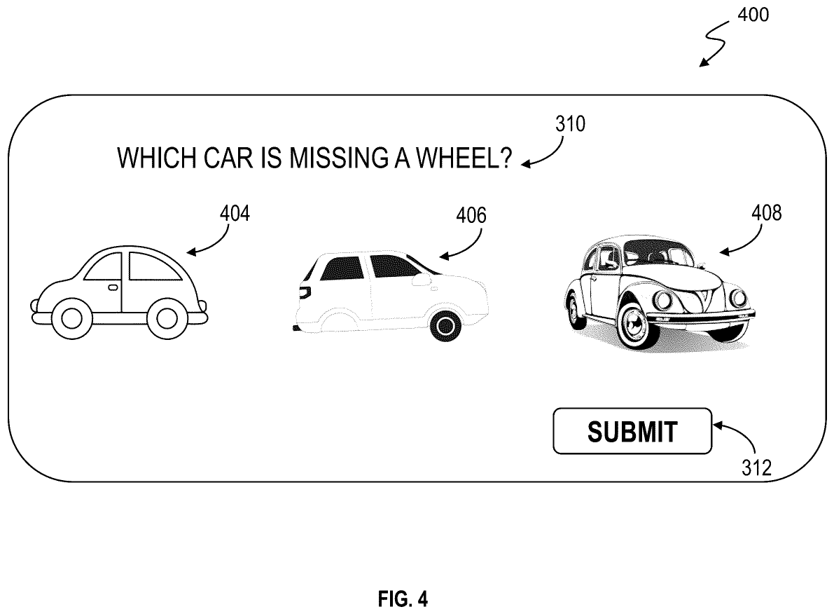

Now referring to FIG. 4, a block diagram of an example challenge-response test 400 generated by the challenge-response authentication system is depicted in accordance with one or more embodiments of the present invention. In some embodiments, the challenge-response test 400 is displayed to a user 302 on a user device 240. The challenge-response test 400 displays a question 310 based on the prompt used to generate the images included in the challenge-response test 400. The questions 310 asks “Which car is missing a wheel?” The images included in the challenge-response test 400 include image 404, image 406, and image 408. Image 404 and image 408 are candidate objects 308 and depict cars without missing wheels. Image 406 is a solution object 306 and depicts a car missing a wheel.

As discussed herein, the solution object 306 is generated by a generative AI engine (e.g., text-to-image AI engine 214) based on a prompt, such as “create an image without a wheel.” The candidate objects 308 are generated by a generative AI engine (e.g., text-to-image AI engine 214) based on a modified prompt, such as “create an image of a car with wheels.” The user 302 reads the question 310 and can select one or more images that answer the question 310. For example, if the user 302 selects image 406, which is an image of a car missing a wheel, and then selects the SUBMIT button 312, a response 314 that includes the selection of the user 302 is generated and transmitted back to the challenge-response authentication system. The authentication module 210 determines that the user selection of image 406 matches the solution object 306, the user device 240 is granted access to the requested resource. If the solution object 306 was not selected, or if the solution object 306 and a candidate object 308 (e.g., image 404 and image 406) were selected, the authentication module 210 determines that the user selection did not match the solution object 306 and the security module 212 performs a security action, such as locking out the user device 240 from accessing the resource or presenting another challenge-response test 400.

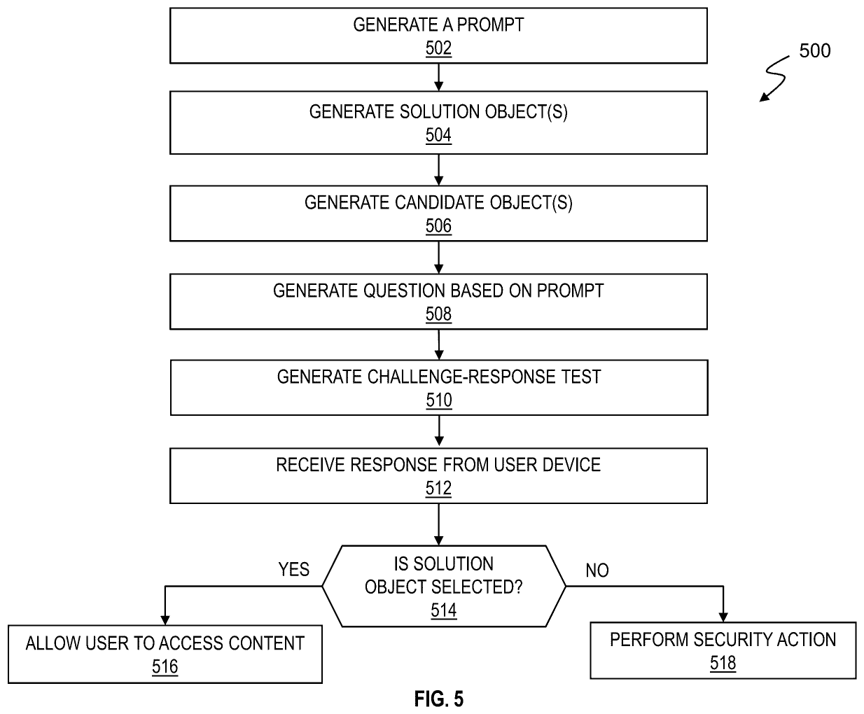

Now referring to FIG. 5, a flowchart of a computer-implemented method 500 for a challenge-response authentication system using generative AI is depicted. The method 500 begins at block 502 by generating a prompt. As discussed above, the authentication module 210 of the computer system 202 receives a request to access a protected resource from a user device 240. In some embodiments, the authentication module 210 receives the request and initiates generation of a challenge-response test 304. The authentication module 210 communicates with the prompt management module 204 of the computer system 202. The prompt management module 204 randomly selects an output type. For example, the prompt management module 204 can select one or more output types, which can include, but is not limited to, audio, video, image, or text.

In some embodiments, the prompt management module 204 will communicate with a generative AI engine, such as text-to-text AI engine 220. To generate a random prompt that will be used to generate an object of the randomly selected output type. For example, the prompt management module 204 instructs the text-to-text AI engine 220 to “create a text to video prompt” if the output type selected is video. The text-to-text AI engine 220 generates the prompt and transmits the prompt to the prompt management module 204.

Next at block 504, one or more solution objects 306 are generated. In some embodiments, the prompt management module 204 transmits the prompt to the object management module 208. The object management module 208 transmits the prompt to the generative AI module 206. The generative AI module 206 selects an AI engine based on the prompt. For example, if the output type in the example is video, the generative AI module 206 selects the text-to-video AI engine 216. The text-to-video AI engine 216 generates one or more solution objects 306 (e.g., video files) and transmits them to the object management module 208. Solution objects 306 are objects that are created and correspond to the prompt. In some embodiments, the number of solution objects 306 is determined by an administrator of the system. In some embodiments, the number of solution objects 306 is a random number that is less than a maximum value for objects that is set for the challenge-response test 304.

Next at block 506, one or more candidate objects 308 are generated. In some embodiments, the object management module 208 communicates with the prompt management module 204. The prompt management module 204 transmits the prompt to the text-to-text AI engine 220, which then generates a modified prompt. In some embodiments, the text-to-text AI engine 220 generates the modified prompt by removing and/or modifying one or more entities or characteristics from the prompt. For example, the prompt “create a video object with trains” is transformed into a modified prompt “create a video object without trains” or “create a video object.”

In some embodiments, the prompt management module 204 transmits the modified prompt to the object management module 208, which it transmits to the generative AI module 206. The generative AI module 206 utilizes the previously selected AI engine to generate one or more candidate objects 308. For the given example, the generative AI module 206 uses the text-to-video AI engine 216 to generate one or more candidate objects 308 and transmits them to the object management module 208.

Next at block 508, a question is generated based on the prompt. In some embodiments, the prompt management module 204 transmits the prompt to the text-to-text AI engine 220 to transform the prompt to a question 310 for the challenge-response test 304. For example, the prompt “create a video object with trains” is transformed into the question “Which video has a train?”

Next at block 510, the authentication module 210 generates the challenge-response test 304 that includes the question 310, the one or more solution objects 306, and the one or more candidate objects 308. The challenge-response test 304 includes a SUBMIT button 312 for the user 302 to select when they have completed making their selection of objects that answer the question 310.

The authentication module 210 facilitates presentation of the challenge-response test 304 on a user device 240. In some embodiments, the challenge-response test 304 includes a button to request generation of a new challenge-response test 304. In response to the user 302 selecting the button to request a new challenge-response test 304, the authentication module 210 generates a new challenge-response test 304 using a different prompt and newly generated solution objects 306 and candidate objects 308 and facilitates presentation of the new challenge-response test 304 on the user device 240.

In some embodiments, the challenge-response test 304 includes a button to request generation of a new challenge-response test 304 that excludes a specific output type. For example, if a user 302 is in an environment where they cannot hear any audio or if their user device 240 is unable to play audio, the user 302 would not be able to complete a challenge-response test 304 that requires the user 302 to listen to audio. In response to the user 302 selecting the button to request a new challenge-response test 304 that excludes an output type, the authentication module 210 generates a new challenge-response test 304 using a different prompt and newly generated solution objects 306 and candidate objects 308 that exclude the specified output type and facilitates presentation of the new challenge-response test 304 on the user device 240.

At block 512, the method 500 further includes receiving a response 314 from the user device 240. The user 302 reads the question 310 and selects one or more objects displayed in the challenge-response test 304 that answer the question 310. When the user 302 has finished selecting objects, the user selects the SUBMIT button 312 of the challenge-response test 304. In response to the selection of the SUBMIT button 312, the response 314 is generated that includes the object selection by the user 302.

The method 500 further includes performing a responsive action in response to receiving the response 314. In some embodiments, the responsive action includes determining if the solution object(s) 306 has been selected at block 514. In some embodiments, the authentication module 210 determines if the response 314 received from the user device 240 indicates that the selection made by the user 302 is the one or more solution objects 306. If the response 314 includes the selection of each of the one or more solution objects 306, the method 500 proceeds to block 516 in which the user device 240 is granted access to the requested resource as the responsive action. In some embodiments, the responsive action includes the authentication module 210 determining that the response 314 does not include each of the one or more solution objects 306, and the method 500 proceeds to block 518 in which a security action is performed.

At block 518, the method 500 includes performing a security action. A security action is one or more actions taken by the security module 212 to protect the requested resource from possible malicious bots. In one example, the security action includes banning/excluding the user 302 and/or the user device 240 from accessing the requested resource. In some embodiments, the security action is presenting the user with a new challenge-response test 304 generated using a newly generated prompt. In some embodiments, the authentication module 210 permits a predetermined number of challenge-response tests 304 to be generated and presented to the user 302 on the user device 240 before taking further action, such as banning/excluding the user 302 and/or the user device 240 or locking out the user 302 and/or user device 240 from accessing the requested resource for a predetermined period of time or locking out the user 302 and/or user device 240 from attempting another challenge-response test 304.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

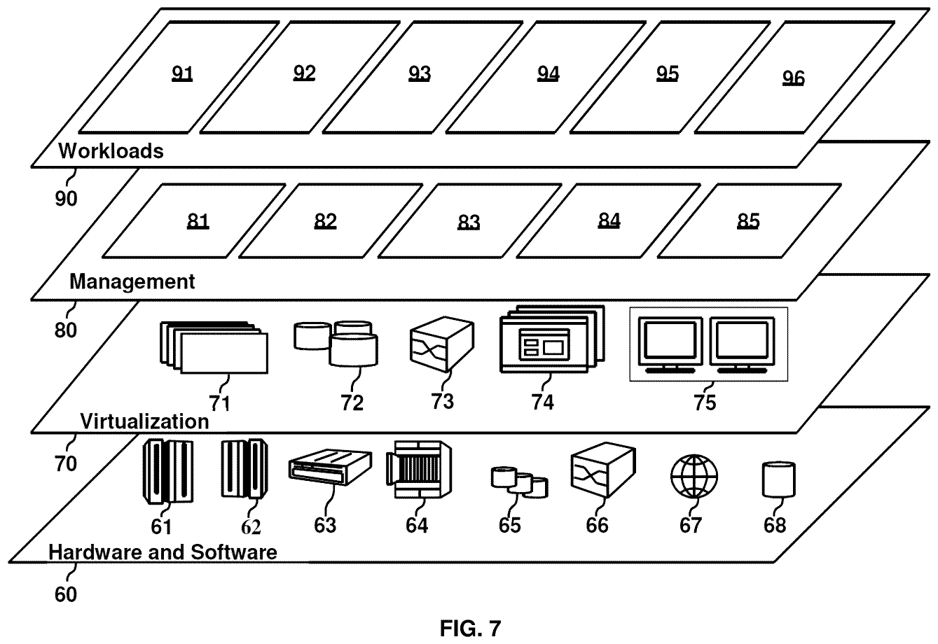

Referring now to FIG. 7, a set of functional abstraction layers provided by cloud computing environment 50 (depicted in FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
generating a prompt for an object of a randomly selected output type;
generating a solution object of the randomly selected output type based on the prompt using a generative artificial intelligence (AI) engine;
generating a candidate object of the randomly selected output type based on a modified prompt using the generative AI engine;
presenting a challenge-response test comprising a question based on the prompt, the solution object, and the candidate object to a user device; and
in response to receiving a response to the challenge-response test from the user device comprising an object selection, performing a responsive action.

2. The computer-implemented method of claim 1, wherein the generative AI engine is a text-to-image generative AI engine, a text-to-video generative AI engine, a text-to-audio generative AI engine, or a text-to-text generative AI engine.

3. The computer-implemented method of claim 1, wherein the responsive action comprises:
determining that the object selection of the response matches the solution object; and
granting the user device access to a protected resource.

4. The computer-implemented method of claim 1, wherein the responsive action comprises:
determining that the object selection of the response does not match the solution object; and
performing a security action comprising preventing access to a protected resource for the user device or presenting a second question, a second solution object, and a second candidate object to the user of the user device.

5. The computer-implemented method of claim 1, further comprising generating the modified prompt by removing an entity from the prompt.

6. The computer-implemented method of claim 1, further comprising:
generating, by a text-to-text generative AI engine, the question based on the prompt.

7. The computer-implemented method of claim 1, wherein the randomly selected output type is audio, video, text, or image.

8. A system comprising:
a memory having computer readable instructions; and
one or more processors for executing the computer readable instructions, the computer readable instructions controlling the one or more processors to perform operations comprising:
generating a prompt for an object of a randomly selected output type;
generating a solution object of the randomly selected output type based on the prompt using a generative artificial intelligence (AI) engine;
generating a candidate object of the randomly selected output type based on a modified prompt using the generative AI engine;
presenting a challenge-response test comprising a question based on the prompt, the solution object, and the candidate object to a user device; and
in response to receiving a response to the challenge-response test from the user device comprising an object selection, performing a responsive action.

9. The system of claim 8, wherein the generative AI engine is a text-to-image generative AI engine, a text-to-video generative AI engine, a text-to-audio generative AI engine, or a text-to-text generative AI engine.

10. The system of claim 8, wherein the responsive action comprises:
determining that the object selection of the response matches the solution object; and
granting the user device access to a protected resource.

11. The system of claim 8, wherein the responsive action comprises:
determining that the object selection of the response does not match the solution object; and
performing a security action comprising preventing access to a protected resource for the user device or presenting a second question, a second solution object, and a second candidate object to the user of the user device.

12. The system of claim 8, wherein the operations further comprise generating the modified prompt by removing an entity from the prompt.

13. The system of claim 8, wherein the operations further comprise:
generating, by a text-to-text generative AI engine, the question based on the prompt.

14. The system of claim 8, wherein the randomly selected output type is audio, video, text, or image.

15. A computer program product comprising a computer readable storage medium having program instructions embodied therewith, the program instructions executable by one or more processors to cause the one or more processors to perform operations comprising:
generating a prompt for an object of a randomly selected output type;
generating a solution object of the randomly selected output type based on the prompt using a generative artificial intelligence (AI) engine;
generating a candidate object of the randomly selected output type based on a modified prompt using the generative AI engine;
presenting a challenge-response test comprising a question based on the prompt, the solution object, and the candidate object to a user device; and
in response to receiving a response to the challenge-response test from the user device comprising an object selection, performing a responsive action.

16. The computer program product of claim 15, wherein the generative AI engine is a text-to-image generative AI engine, a text-to-video generative AI engine, a text-to-audio generative AI engine, or a text-to-text generative AI engine.

17. The computer program product of claim 15, wherein the responsive action comprises:
determining that the object selection of the response matches the solution object; and
granting the user device access to a protected resource.

18. The computer program product of claim 15, wherein the responsive action comprises:
determining that the object selection of the response matches the solution object; and
performing a security action comprising preventing access to a protected resource for the user device or presenting a second question, a second solution object, and a second candidate object to the user of the user device.

19. The computer program product of claim 15, wherein the operations further comprise generating the modified prompt by removing an entity from the prompt.

20. The computer program product of claim 15, wherein the operations further comprise:
generating, by a text-to-text generative AI engine, the question based on the prompt.
